(19) United States
(12) Patent Application Publication
(10) Pub. No.: US 2005/0281552 A1
(43) Pub. Date: Dec. 22, 2005

(54) Image capturing apparatus, image capturing system, and housing

(75) Inventors: Yoshito Konishi, Osaka (JP); Michiko Kaihotsu, Osaka (JP); Osamu Tanaka, Hashimoto-shi (JP); Koji Yasuda, Osaka (JP); Tomoji Fujii, Osaka (JP)

Correspondence Address: BRINKS HOFER GILSON & LIONE, P.O. BOX 10395, CHICAGO, IL, 60610, US

(73) Assignee: KONICA MINOLTA PHOTO IMAGING, INC.

(21) Appl. No.: 11/158,226

(22) Filed: Jun. 21, 2005

(30) Foreign Application Priority Data
Jun. 22, 2004 (JP) JP2004-183963

(51) Int. Cl. G03B 17/04

(52) U.S. Cl. 396/301; 396/448; 396/529

(57) ABSTRACT

A camera has a lens barrier which can move between a closed position where a taking lens is covered and an opened position where the taking lens is exposed, and the on/off state of a power source is switched interlockingly with the open/close state of the lens barrier. A housing for housing the camera has a barrier driving lever for driving the lens barrier. At the time of attaching the housing, the tip of the barrier driving lever is retained by a finger retaining part of the camera to move the lens barrier to the opened position. As a result, attachment of the housing in a power-off state made by the lens barrier can be prevented.

This application is based on application No. 2004-183963 filed in Japan, the contents of which are hereby incorporated by reference.

### BACKGROUND OF THE INVENTION

1. Field of the Invention

The present invention relates to a technique of an image capturing apparatus to which a predetermined housing can be attached.

2. Description of the Background Art

In recent years, a digital camera having a refractive zoom optical system for refracting light of the subject by a prism or the like by 90 degrees is commercially available. Since the refractive zoom optical system moves a zoom lens within the camera body, a camera cone does not project from the camera body.

As disclosed in, for example, Japanese Patent Application Laid-Open No. 10-333233 (1998), by housing a digital camera in a housing (underwater case), underwater image capturing or the like can be performed. Since the camera cone does not project as described above, a camera having a refractive zoom optical system is suitable for performing underwater image capturing or the like by using a housing.

On the other hand, some cameras each having a refractive zoom optical system have an outer lens barrier (hereinafter, simply referred to as a “lens barrier”) covering a lens in order to protect an objective lens when the camera is not used.

The power source of the camera is turned on/off interlockingly with slide of the lens barrier so as to be open/close by manual operation of the user.

The camera, however, has a problem such that when the housing is attached in a state where the lens barrier is closed (power off) at the time of image capturing in the water or the like, the housing has to be opened to open the lens barrier (to turn on the power), so that the user may miss the right moment to take a picture. This problem will be described concretely below.

FIGS. 30 and 31 are diagrams for illustrating an image capturing system 90 as the background art of the present invention. FIGS. 30 and 31 are front views and show a state where a camera with a lens barrier opened is housed and a state where the camera with the lens barrier closed is housed, respectively.

The image capturing system 90 is constructed by a camera 91 and a housing 92 for housing the camera 91. The camera 91 is provided with a slidable lens barrier 94 for protecting a taking lens 93.

As shown in FIG. 31, when the lens barrier 94 is housed in a closed state in the housing 92, it is difficult to move the lens barrier 94 to the opened state by a user operation.

Therefore, as described above, it is necessary to open the housing 92, move the lens barrier 94 so as to be opened, and attach the housing 92 again, so that the user may miss the right moment to take a picture.

### SUMMARY OF THE INVENTION

The present invention is directed to an image capturing apparatus to which a predetermined housing can be attached.

According to the present invention, the image capturing apparatus comprises: (a) a taking lens; (b) a lens protection member which can be moved between a closed position where the taking lens is covered and an opened position where the taking lens is exposed; and (c) a power source switcher which switches between a power-on state and a power-off state interlockingly with movement in an opened direction of the lens protection member and movement in a closed direction. Herein, the lens protection member is moved in the opened direction by a predetermined member provided for the predetermined housing in association with a work of attaching the predetermined housing. With the configuration, attachment of the housing can be prevented in the power-off state made by the lens protection member.

In a preferred embodiment of the present invention, in the image capturing apparatus, the lens protection member is moved to the opened position by the predetermined member. Therefore, attachment of the housing in the power-off state can be prevented reliably.

The present invention is also directed to an image capturing system and a housing.

Therefore, an object of the present invention is to provide a technique of an image capturing apparatus, which can prevent attachment of a housing in a power-off state made by a lens barrier.

These and other objects, features, aspects and advantages of the present invention will become more apparent from the following detailed description of the present invention when taken in conjunction with the accompanying drawings.

### DESCRIPTION OF THE DRAWINGS

FIGS. 1 to 4 are diagrams showing a configuration of a main part of a camera according to a first preferred embodiment of the present invention;

FIG. 5 is a diagram illustrating a closed state of a lens barrier;

FIGS. 6 and 7 are diagrams illustrating a refractive zoom optical system of the camera;

FIG. 8 is a diagram showing functional blocks of the camera;

FIGS. 9 and 10 are diagrams showing the configuration of a main part of a housing;

FIGS. 11A and 11B are diagrams illustrating a barrier driver;

FIG. 12 is a flowchart showing basic operations of an image capturing system;

FIG. 13 is a flowchart showing operations of determining housing into a housing;

FIG. 14 is a flowchart showing operations of a housing mode process;

FIGS. 15 and 16 are diagrams showing the configuration of a main part of an image capturing system according to a second preferred embodiment of the present invention;

FIGS. 17A and 17B are diagrams illustrating detection of the position of the lens barrier;

FIG. 18 is a diagram illustrating a barrier blocking lever;

FIG. 19 is a diagram illustrating the barrier driver of a housing;

FIGS. 20 and 21 are diagrams showing the configuration of a main part of an image capturing system according to a third preferred embodiment of the present invention;

FIG. 22 is a diagram illustrating functions of an attachment preventing rib;

FIGS. 23 and 24 are diagrams showing the configuration of a main part of an image capturing system according to a fourth preferred embodiment of the present invention;

FIG. 25 is a diagram illustrating functions of an attachment preventing rib;

FIGS. 26 and 27 are diagrams illustrating an external power source button of a housing;

FIG. 28 is a diagram showing a state of the case where the external power source button is depressed;

FIG. 29 is a flowchart showing basic operations of the image capturing system; and

FIGS. 30 and 31 are diagrams illustrating an image capturing system according to a background technique of the present invention.

### DESCRIPTION OF THE PREFERRED EMBODIMENTS

### First Preferred Embodiment

Configuration of Image Capturing system

An image capturing system 1A according to a first preferred embodiment of the present invention is constructed by a camera 2A functioning as an image capturing apparatus and a housing 5A for housing the camera 2A. First, the configuration of the camera 2A will be described below.

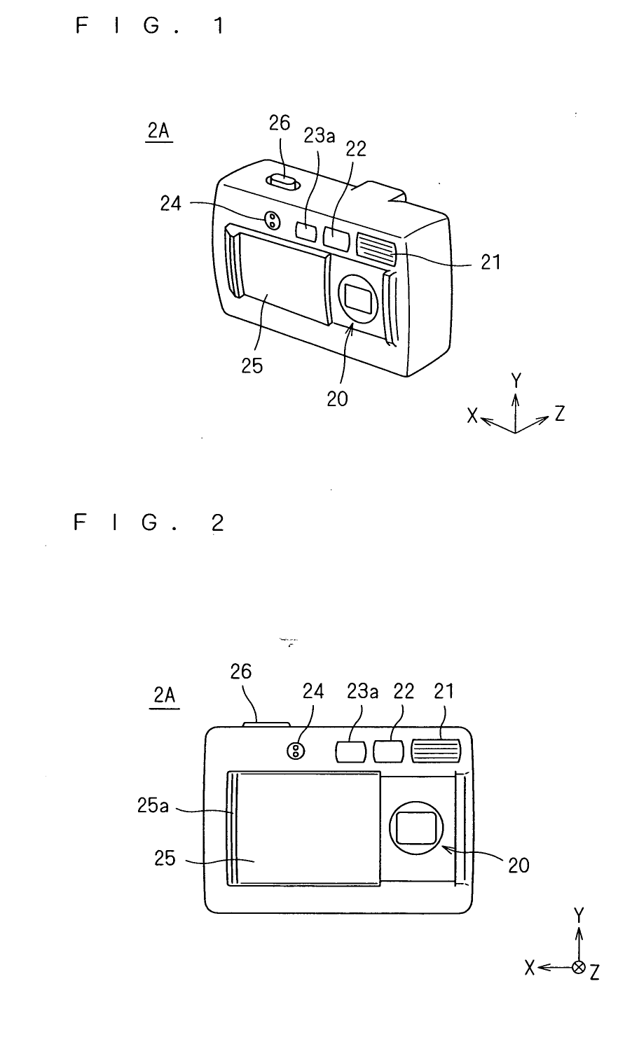

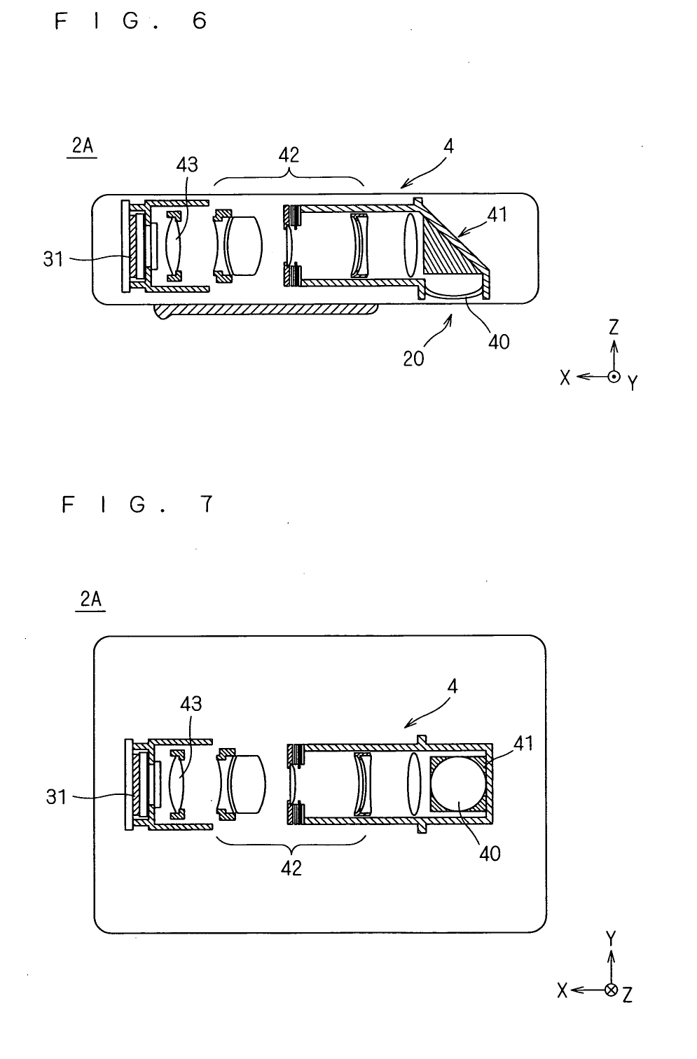

FIGS. 1 to 4 are diagrams showing the configuration of a main part of the camera 2A. FIGS. 1 to 4 are an external view, a front view, a rear view and a top view of the camera 2A, respectively. In the following description, the directions and orientations will be described by properly using an XYZ three-dimensional rectangular coordinate system shown in the figures.

The camera 2A is constructed as, for example, a digital camera and has a taking lens 20 in the front face. In the front face of the camera 2A, an electronic flash 21, an AF sensor 22, a viewfinder window 23a on the objective side, and a recording microphone 24 are provided.

The AF sensor 22 is constructed as a range sensor for measuring the distance to a subject. In an auto-focus (AF) control at the normal time in the camera 2A, a prompt AF control is performed by using both an AF based on a measurement value of the AF sensor 22 and a video AF based on an image captured by an image capturing device 31 (see FIG. 8). As will be described later, at the time of attachment of the housing 5A, only the video AF is performed.

In the front face of the camera 2A, a lens barrier 25 which slides to cover the front of the taking lens 20 is also provided. The lens barrier 25 can be moved in the X direction by a manual operation with fingers of the user moving a finger retaining part 25a as a projection.

The lens barrier 25 is a lens protection member for protecting the taking lens 20 when the camera 2A is not used, and can move between a closed position where the taking lens 20 is covered and an opened position where the taking lens 20 is exposed.

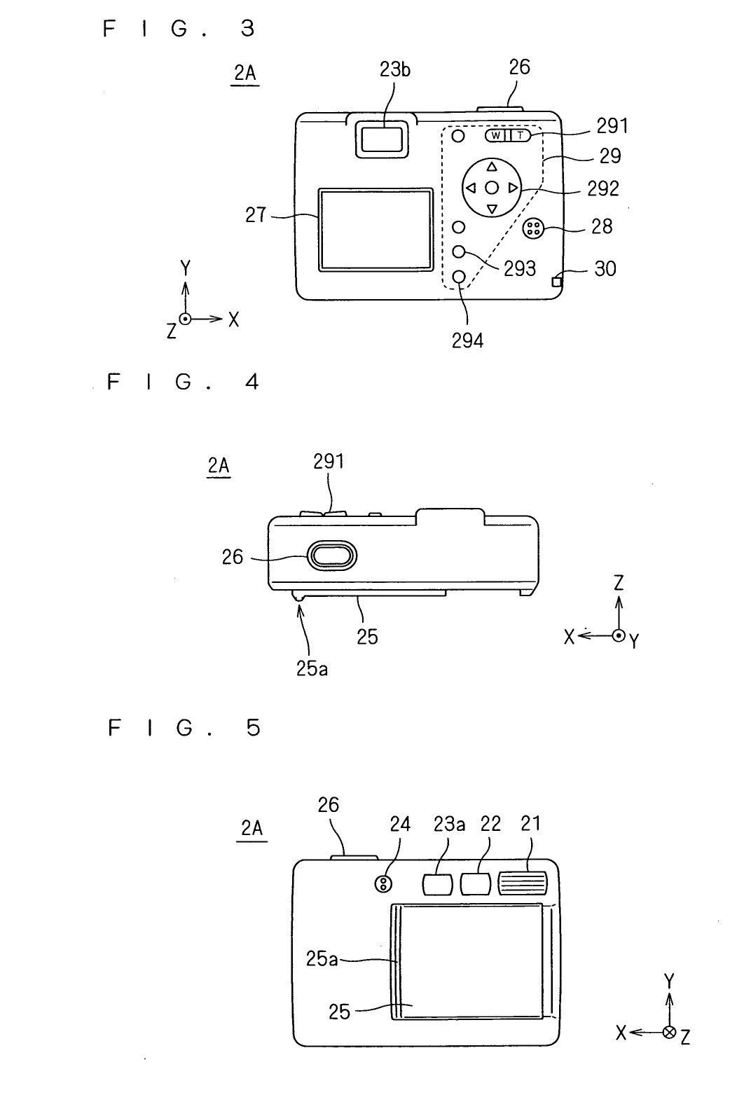

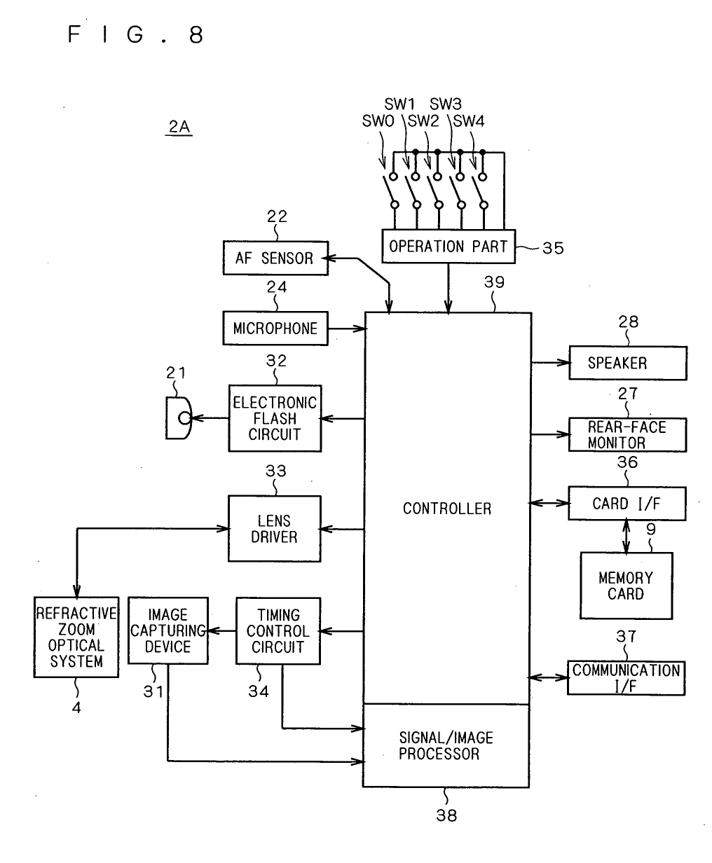

The lens barrier 25 also has the function of a power source switch. Concretely, in the opened state of the lens barrier 25 where the taking lens 20 is exposed as shown in FIG. 2, the power source of the camera 2A is turned on. On the other hand, in the closed state of the lens barrier 25 where the taking lens 20 is covered as shown in FIG. 5, the power source of the camera 2A is turned off. That is, interlockingly with the movement in the opened direction and the movement in the closed direction of the lens barrier 25, the power source is switched between the on state and the off state.

A shutter start button 26 for accepting an operation of an image capturing instruction is provided on the top face of the camera 2A.

In the rear face of the camera 2A, a viewfinder window 23b on the eyepiece side corresponding to the viewfinder window 23a on the objective side, a rear-face monitor 27, a speaker 28, a rear-face operation button part 29, and a housing detector 30 are provided.

The rear-face monitor 27 takes the form of, for example, a liquid crystal display and displays a captured image of a subject and the like.

The rear-face operation button part 29 is constructed by a plurality of operation buttons disposed on the rear face of the camera 2A and includes, for example, a zoom button 291 for instructing scaling (zooming), a crossed operation key 292, and operation buttons 293 and 294 to which specific functions are assigned.

The housing detector 30 detects whether the housing 5A is attached to the camera 2A or not, that is, an attached state and an unattached state by determining whether a rib 59 for detecting housing of the housing 5A (which will be described later) comes into contact with the housing detector 30 or not.

The camera 2A has a refractive zoom optical system which will be briefly described below.

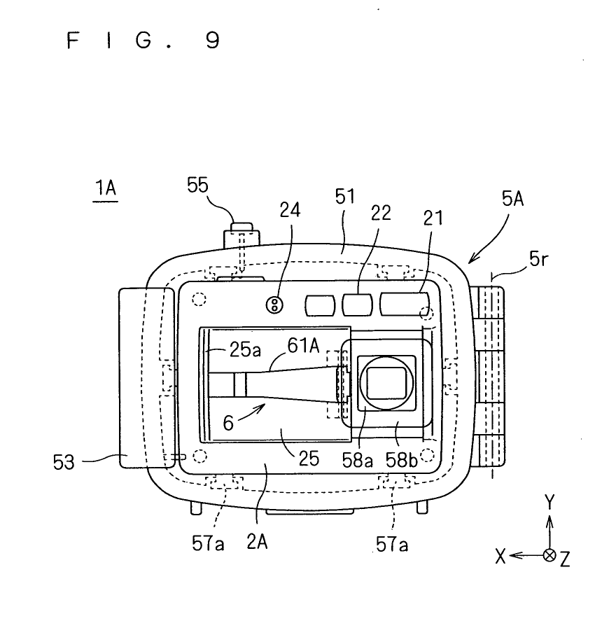

FIGS. 6 and 7 are diagrams illustrating a refractive zoom optical system 4 of the camera 2A and correspond to a sectional view in an XZ plane of the camera 2A and a sectional view in an XY plane, respectively.

In the refractive zoom optical system 4, the travel course of light of the subject passing an objective lens 40 corresponding to the taking lens 20 and incident in the Z-axis direction is changed to the X-axis direction by a prism (or mirror) 41. The light passes through a zoom lens part 42 and a focus lens part 43 in the refractive zoom optical system 4 and an image of the light is formed on the image capturing device 31 taking the form of, for example, a CCD.

By changing the positional relations of a plurality of lenses in the zoom lens part 42 in the refractive zoom optical system 4 for refracting light of the subject at the right angle, the scaling (zooming) is performed. With such a configuration, the camera cone is not projected from the front face of the camera 2A at the time of zooming.

FIG. 8 is a diagram showing functional blocks of the camera 2A.

The camera 2A has an electronic flash circuit 32 for controlling light emission of the electronic flash 21 and a controller 39 electrically connected to the electronic flash circuit 32.

The camera 2A also has a lens driver 33 for driving lenses in the refractive zoom optical system 4 and a timing control circuit 34 for controlling the driving timing of the image capturing device 31.

The camera 2A has an operation part 35 including the shutter start button 26 and the rear-face operation button part 29 and accepting an operation input from the user. For the operation part 35, switches SW0 to SW4 used in the operation of the camera 2A (which will be described later) are provided.

The camera 2A has a card interface (I/F) 36 for transmitting/receiving data to/from a memory card 9 and a communication interface (I/F) 37 for performing communication with the outside of the camera 2A.

The camera 2A also has a signal/image processor 38 for converting an analog image signal obtained by the image capturing device 31 into a digital signal and performing an image process such as white balance correction.

The controller 39 has a CPU, a memory, and the like and controls the above-described components in a centralized manner.

The configuration of the housing 5A for housing the camera 2A having the above-described configuration will now be described.

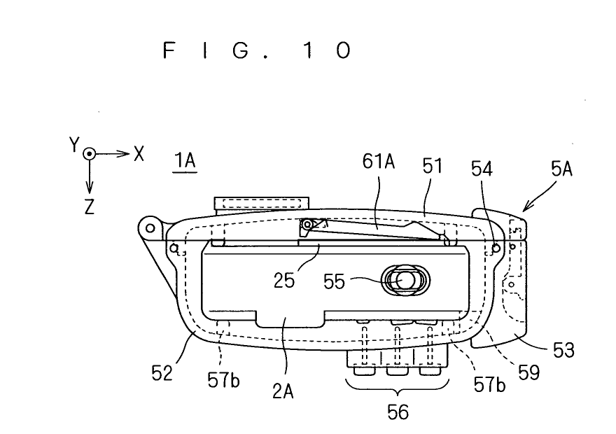

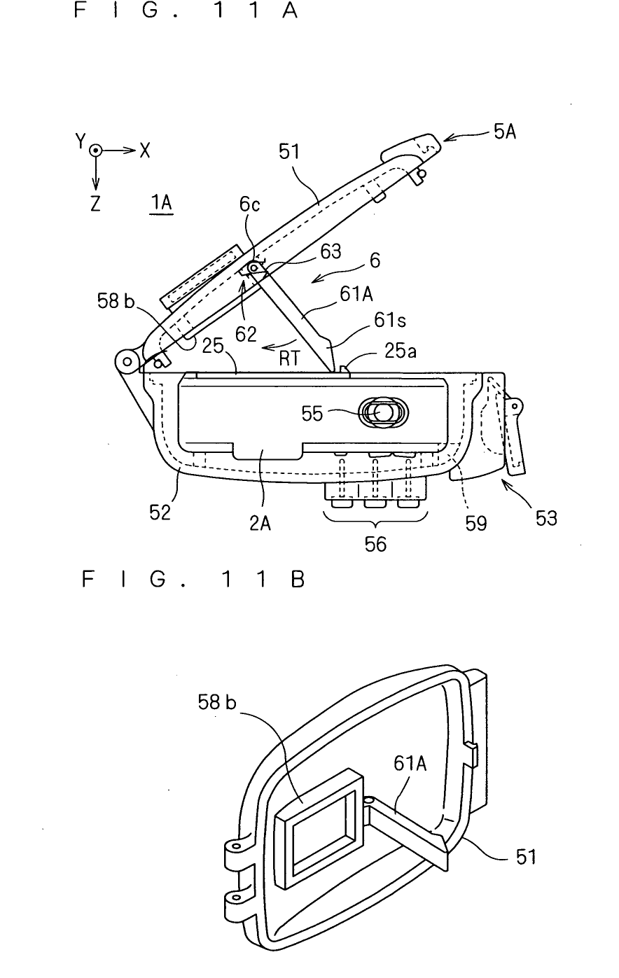

FIGS. 9 and 10 are diagrams showing the configuration of a main part of the housing 5A. FIGS. 9 and 10 are a front view and a top view of the housing 5A, respectively, and show a state where the camera 2A is housed.

The housing 5A is constructed as a waterproof case for housing the camera 2A in order to take pictures in predetermined image capturing environments, for example, in the water. A front housing 51 and a rear housing 52 swing around a swing shaft 5r as a center, and the camera 2A is housed in the space formed by the front housing 51 and the rear housing 52. When the camera 2A is housed, the housing 5A is locked by a buckle 53 so as to press a waterproof packing 54. By attaching the housing 5A to the camera 2A in such a manner, pictures can be taken in the water.

The housing 5A has, in its top face, an external shutter start button 55 for operating the shutter start button 26 of the camera 2A over the housing 5A and has, in its rear face, an external rear-face operation button part 56 for operating the rear-face operation button part 29 of the camera 2A.

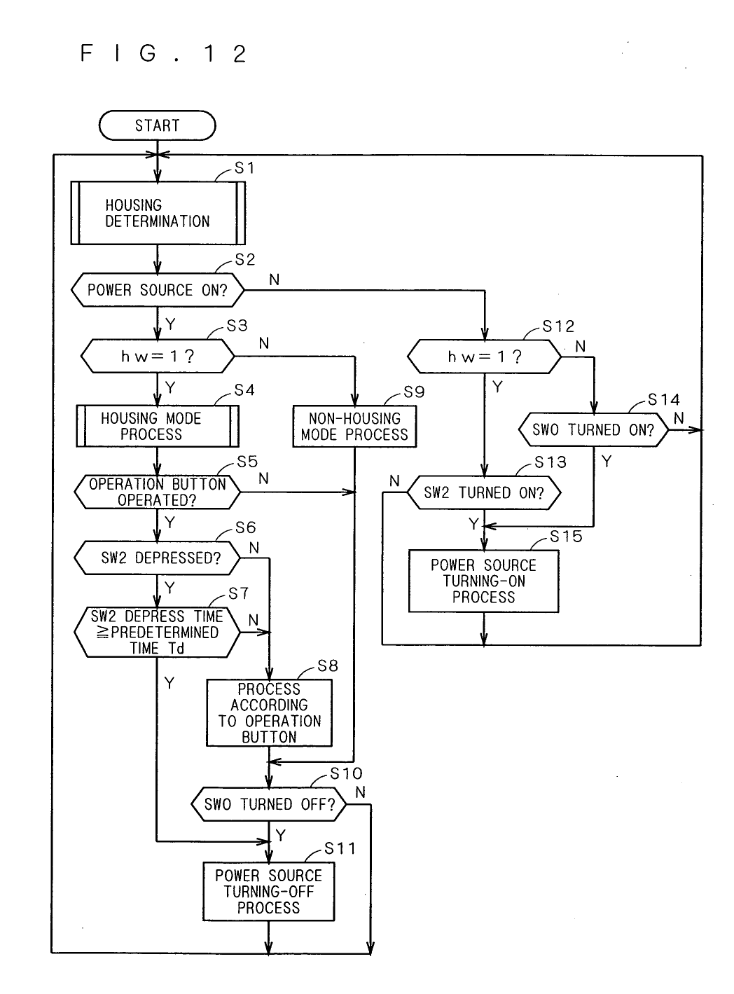

The housing 5A also has a camera holding rubber 57a and a camera holding projection 57b for stably holding the camera 2A, and an image capturing window 58a is provided in front of the taking lens 20 of the camera 2A. Between the image capturing window 58a and the taking lens 20, a stray light blocking member 58b having a cylindrical shape is disposed in order to block stray light such as reflection light and electronic flash light caused by the transparent housing (see FIG. 11B).

The housing 5A has the rib 59 for detecting a housing, which operates in contact with the housing detector 30 of the camera 2A. With the configuration, in the case where the camera 2A is housed in the housing 5A, the housing 5A can be reliably detected by the housing detector 30.

The housing 5A also has a barrier driver 6 for making the lens barrier 25 of the camera 2A slid so as to be open. The barrier driver 6 will be described below.

FIGS. 11A and 11B are diagrams illustrating the barrier driver 6. FIG. 11A is a diagram corresponding to FIG. 10 showing the state where the camera 2A is housed and shows the state before the camera 2A is housed. FIG. 11B is an external view of the front housing 51 when seen from the obliquely rear side.

The barrier driver 6 has a barrier driving lever (driving member) 61A whose tip 61s is retained by the finger retaining part 25a of the camera 2A to move the lens barrier 25 so as to be open.

Although the barrier driving lever 61A can swing around a swing shaft 6c as a center, the swing is regulated by a stopper 62 at the angle shown in FIG. 1A. The barrier driving lever 61A is energized in a swing direction RT by an energizing spring 63 such as a torsion coil spring.

Also in the case where the lens barrier 25 of the camera 2A is closed by the barrier driver 6 having such a configuration, at the time of closing the front housing 51, the tip 61s of the barrier driving lever 61A comes into contact with the lens barrier 25 as shown in FIG. 11A and moves the lens barrier 25 so as to open. Consequently, the lens barrier 25 shifts to the open state when the camera 2A is housed as shown in FIG. 9. As described above, accompanying the work of attaching the housing 5A, the lens barrier 25 is moved to the open position by the barrier driving lever 61A. Therefore, in the camera 2A housed in the housing 5A, the lens barrier 25 is reliably set in the opened state, that is, the power source is turned on, so that the user does not miss the right moment to take a picture.

The operation of the image capturing system 1A having the camera 2A and the housing 5A described above will now be described below.

FIG. 12 is a flowchart showing basic operation of the image capturing system 1A. The operation is executed by the controller 39 of the camera 2A. In the following, a flag “hw” is used and whether the housing is housing the camera 2A or not is determined.

In step S1, a housing determination operation of determining whether the camera 2A is housed in the housing 5A or not is performed (the details will be described later).

In step S2, whether the power source is on or not is determined. If the power source is on, the program advances to step S3. When the power source is off, the program advances to step S12.

In step S3, whether the flag “hw” set in step S1 is “1” or not is determined. When the flag “hw” is 1, the program advances to step S4. When the flag “hw” is 0, the program advances to step S9.

In step S4, a housing mode process is performed (the details will be described later). By the operation in step S4 and an operation in step S9 which will be described later, a control method on control items related to underwater image capturing is switched between the state where the housing 5A is attached and the state where the housing 5A is not attached.

In step S5, whether an operation button in the operation part 35 is operated by the user or not is determined. If an operation button is operated, the program advances to step S6. If an operation button is not operated, the program advances to step S10.

In step S6, whether the switch SW2 in the operation buttons of the operation part 35 is depressed or not is determined. The switch SW2 functions as a power source switch when the housing 5A is attached. For example, a central button of a crossed operation key 292 of the camera 2A is used as the switch SW2. Specifically, when the housing 5A is attached to the camera 2A, the power source is switched between the on state and the off state by an operation on another member (switch SW2) different from the lens barrier 25.

When the switch SW2 is depressed in step S6, the program advances to step S7. When the switch SW2 is not depressed, the program advances to step S8.

In step S7, whether depression time of the switch SW2 is equal to or longer than predetermined time Td (for example, three seconds) is determined. The reason for measuring the depression time of the switch SW2 is to prevent the power source from being easily turned off in a case such that the user touches the switch SW2 by mistake.

When the depression time of the switch SW2 is equal to or longer than the predetermined time Td, the program advances to step S11. When it is less than the predetermined time Td, the program advances to step S8.

In step S8, a process according to an operation button in the operation part 35 is performed.

In step S9, a non-housing mode process as a normal process in the camera 2A is executed.

In step S10, whether the switch SW0 in the operation part 35 has shifted from the on state to the off state or not is determined. The switch SW0 is a switch for turning on/off the power source in accordance with the opened/closed state of the lens barrier 25. In the case where the switch SW0 is set to the off state, the program advances to step S1. In the case where the switch SW0 remains on, the program returns to step S1.

In step S11, a process of turning off the power of the camera 2A is performed.

In step S12, whether the flag “hw” set in step S1 is “I” or not is determined. When the flag “hw” is “I”, the program advances to step S13. When the flag “hw” is “0”, the program advances to step S14.

In step S13, whether the switch SW2 in the operation part 35 is on or not. When the switch SW2 is on, the program advances to step S15. When the switch SW2 is off, the program returns to step S1.

In step S14, whether or not the switch SW0 in the operation part 35 is switched from the off state to the on state is determined. In the case whether the switch SW0 is switched to the on state, the program advances to step S15. In the case where the switch SW0 remains off, the program returns to step S1.

In step S15, a process of turning on the power source of the camera 2A is performed.

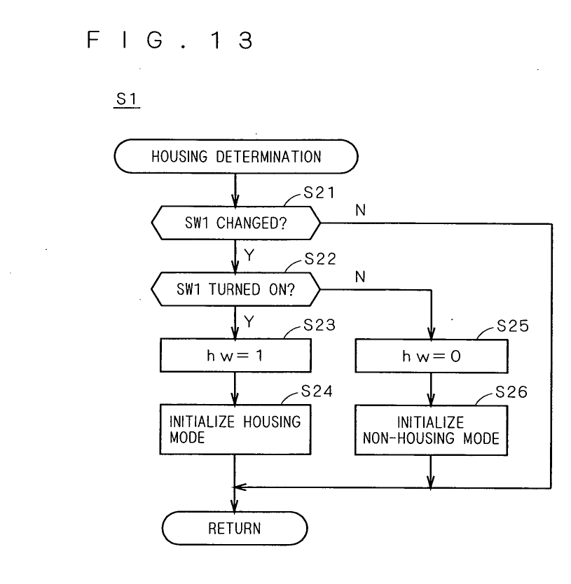

FIG. 13 corresponds to step S1 and is a flowchart showing operations of housing determination.

In step S21, whether the state of the switch SW1 in the operation part 35 has changed or not is determined. The switch SW1 is a switch corresponding to the housing detector 30 in the camera 2A. When the switch S1 has changed, the program advances to step S22. When there is no change, the program goes out from the routine of this flowchart and advances to step S2.

In step S22, whether the switch SW1 is on or not is determined. When the switch SW1 is on, that is, when the housing detector 30 detects attachment of the housing 5A, the program advances to step S23. When the switch SW1 is off, the program advances to step S25.

In step S23, “I” is substituted for the flag “hw”.

In step S24, the housing mode is initialized.

In step S25, “0” is substituted for the flag “hw”.

In step S26, the non-housing mode is initialized.

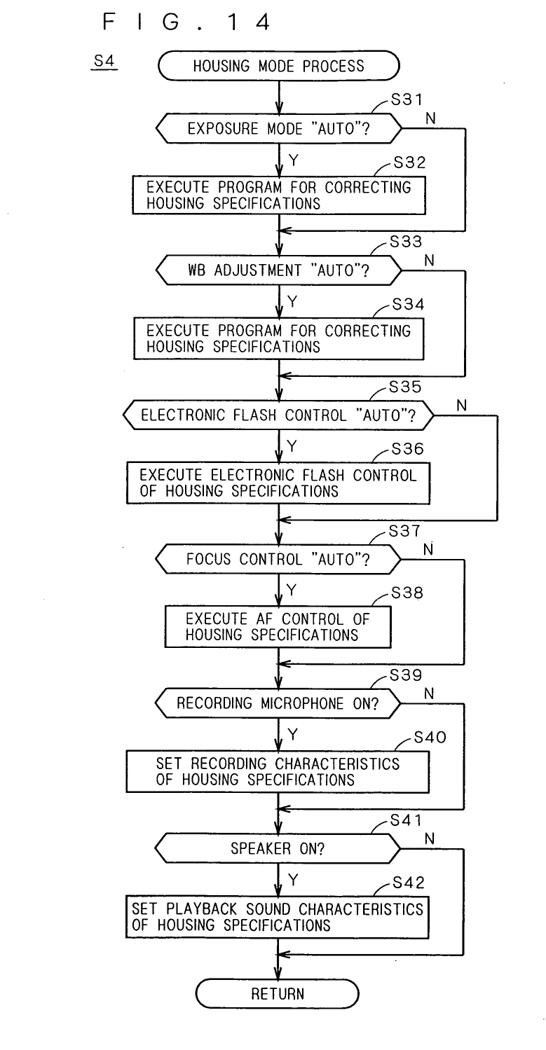

FIG. 14 corresponds to step S4 and is a flowchart showing operations of the housing mode process.

In step S31, whether the exposure mode of the camera 2A is set to “auto” (automatic) or not is determined. In the case where the exposure mode is set to “auto”, the program advances to step S32. In the case where the exposure mode is not set to “auto”, the program advances to step S33.

In step S32, a program of correcting specifications of the housing adapted to underwater image capturing is executed. A concrete example will be given. Instead of an exposure control based on an averaging metering value of an image captured by the image capturing device 30 in the no-housing mode, an exposure control based on spot metering, for example, a metering value in the central portion of the image is executed. By the operation, a proper exposure control can be performed in the water.

In step S33, whether white balance (WB) adjustment of the camera 2A is set to “auto” or not is determined. In the case where the WB adjustment is set to “auto”, the program advances to step S34. In the case where the WB adjustment is not set to “auto”, the program advances to step S35.

In step S34, a program for correcting specifications of the housing adapted to underwater image capturing is executed. To be specific, since the tendency of colors in the underwater image capturing differs from that in normal image capturing, a white balance control in which a proper value in the underwater image capturing is set is performed.

In step S35, whether the electronic flash control of the camera 2A is set to “auto” or not is determined. In the case where the electronic flash control is set to “auto”, the program advances to step S36. In the case where the electronic flash control is not set to “auto”, the program advances to step S37.

In step S36, an electronic flash control of the housing specifications adapted to the underwater image capturing is executed. Specifically, since light attenuation in the water is larger than that in the air, an electronic flash control with a light emission amount which is set in consideration of the attenuation is performed.

In step S37, whether the focus control of the camera 2A is set to “auto” or not is determined. In the case where the focus control is set to “auto”, the program advances to step S38. In the case where the focus control is not set to “auto”, the program advances to step S39.

In step S38, an auto focus (AF) control of the housing specifications adapted to the underwater image capturing is executed. Concretely, an AF control is performed only by video AF without using the AF sensor 22 whose precision deteriorates in the water.

In step S39, whether the recording microphone 24 is on or not is determined. In the case where the recording microphone 24 is on, the program advances to step S40. In the case where the recording microphone 24 is off, the program advances to step S41.

In step S40, recording characteristics of housing specifications adapted to the underwater image capturing are set. Specifically, since sound does not travel so much in the water, a recording characteristic changing control of, for example, eliminating sound in a predetermined band by changing the frequency characteristic is performed.

In step S41, whether the speaker 28 is on or not is determined. In the case where the speaker 28 is on, the program advances to step S42. In the case where the speaker 28 is off, the program goes out from the routine of the flowchart and advances to step S5.

In step S42, playback sound characteristics of the housing specifications adapted to the underwater image capturing are set. Specifically, since sound does not travel so much, a playback sound characteristic changing control of, for example, eliminating sounds in a predetermined band by changing the frequency characteristic is performed.

By the operations in steps S31 to S42, the controls on the camera 2A adapted to the underwater image capturing are executed. It is not necessary to change the control methods of all of the six items of the exposure control, white balance control, electronic flash control, auto-focus control, recording characteristic control, and playback sound characteristic control. The control method of at least one of the control items may be changed.

Since the lens barrier 25 in the camera 2A can be moved to the opened position by the barrier driving lever 61A at the time of housing the camera 2A in the housing 5A with the above-described configuration and operations of the image capturing system 1A, with a relatively simple mechanism, the power source of the camera 2A can be turned on at the time of attaching the housing 5A, so that the user does not miss the right moment to take a picture when the housing is attached. Since the lens barrier can be opened interlockingly with the work of attaching the housing 5A by the barrier driving lever 61A, the work of moving the lens barrier to the opened position performed by the user can be omitted.

In the image capturing system 1A, also at the time the housing is attached, the power source can be turned on or off by operating the switch SW2 on the housing. Consequently, unlike the conventional camera in which the power source can be turned off only by auto power-off during attachment of the housing, the user does not have to wait for the auto power-off while minding exhaustion of the battery.

### Second Preferred Embodiment

An image capturing system 1B according to a second preferred embodiment of the present invention is constructed by a camera 2B and a housing 5B for housing the camera 2B. The configuration will be described below.

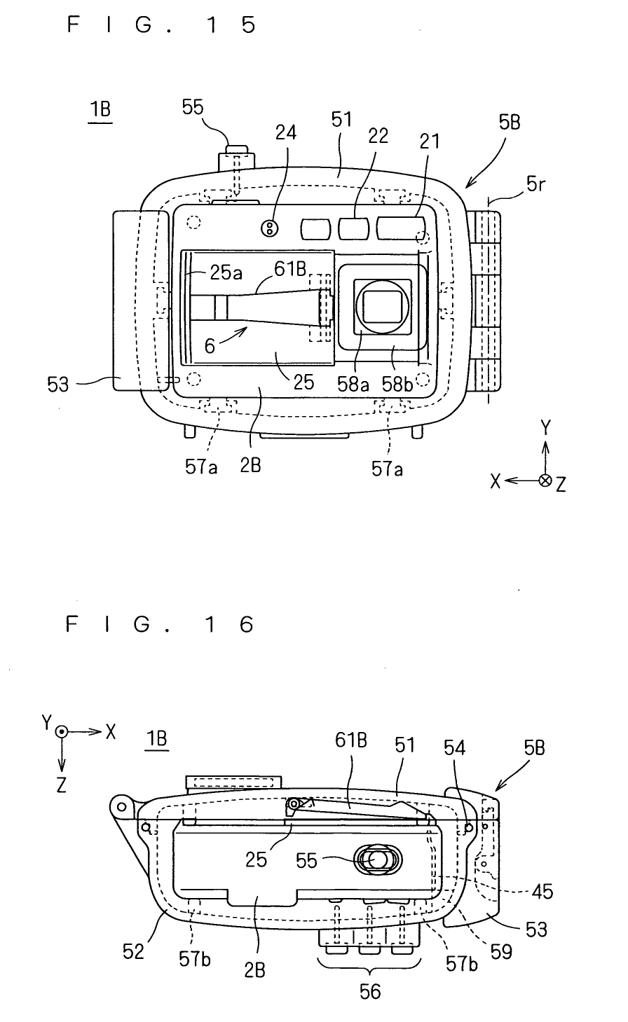

FIGS. 15 and 16 are diagrams showing the configuration of a main part of the image capturing system 1B. FIGS. 15 and 16 are a front view and a top view of the image capturing system 1B, respectively, and show a state where the camera 2B is housed in the housing 5B.

The camera 2B has a configuration similar to that of the camera 2A of the first preferred embodiment shown in FIGS. 1 to 4 but is different from the camera 2A mainly with respect to the point that a barrier blocking lever 45 is internally added. The barrier blocking lever 45 will be described below.

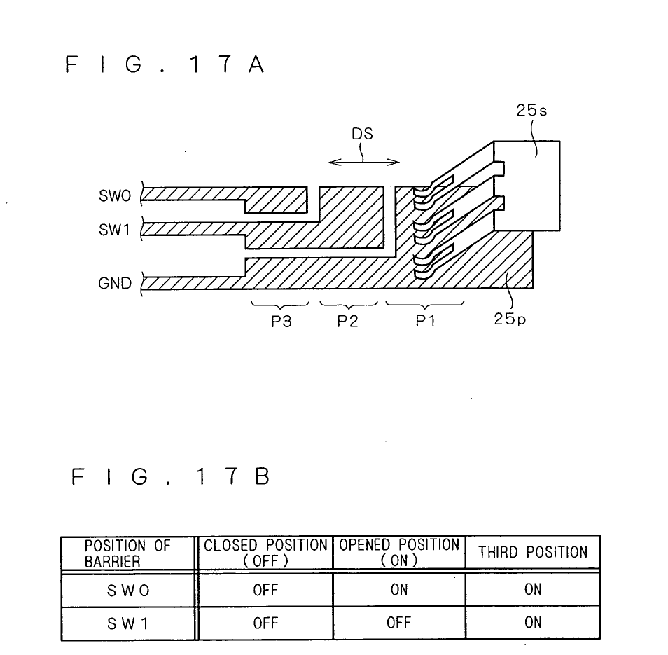

In the camera 2B, the lens barrier 25 can slide not only to the closed and opened positions described in the first preferred embodiment but also to a third position which is further in the opened direction from the opened position. The closed position, the opened position, or the third position of the lens barrier 25 is detected by determining, as shown in FIG. 17A, the position of a slide contact piece 25s attached to the lens barrier 25 and moves in the directions DS (X-axis directions), which is a closed position P1, an opened position P2, or a third position P3 of a wiring pattern 25p. To be concrete, as shown in FIG. 17B, in the case where the switch SW0 is on and the switch SW1 is off, it is determined that the lens barrier 25 is in the opened position. In the case where the switch SW0 is on and the switch SW1 is on, it is determined that the lens barrier 25 is in the third position.

At the normal time in which the housing 5B is not attached, the lens barrier 25 is not moved to the third position. The movement is blocked by the barrier blocking lever 45.

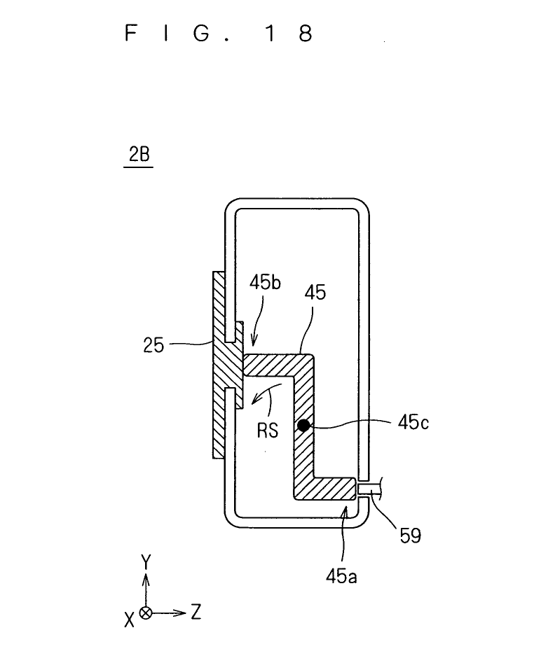

FIG. 18 is a diagram illustrating the barrier blocking lever 45.

The barrier blocking lever 45 has a Z-letter shape and is swingable around a swing shaft 45c as a center. At the normal time when the camera 2B is not housed in the housing 5B, the barrier blocking lever 45 swings in the direction RS by the energizing force of the spring, and an end 45b is fit in a slide path of the lens barrier 25 between the opened position and the third position, thereby blocking the movement of the lens barrier 25 to the third position. On the other hand, at the time of housing when the camera 2B is housed in the housing 5B, the rib 59 for detecting a housing comes into contact with an end 45a of the barrier blocking lever 45, so that a posture as shown in FIG. 18 is obtained. Since the end 45b moves apart from the lens barrier 25 and withdraws from the slide path of the lens barrier 25, the lens barrier 25 can move to the third position.

As shown in FIG. 19, the state before the camera 2B is housed in the housing 5B is similar to that in the case of the first preferred embodiment shown in FIG. 11 except that the mounting position of a barrier driving lever 61B is slightly different from that of the barrier driving lever 61A of the first preferred embodiment. With the mounting position of the barrier driving lever 61B, the lens barrier 25 is moved to the third position deeper than (in the opened direction of) the opened position.

By the barrier driver 6 of the housing 5B having such a configuration, also in the case where the lens barrier 25 of the camera 2B is in a closed state, at the time of closing the front housing 51, as shown in FIG. 19, the tip 61s of the barrier driving lever 61B comes into contact with the lens barrier 25 and makes the lens barrier 25 slide in the closed direction. In this case, the regulation of the movement of the lens barrier 25 to the third position by the barrier blocking lever 45 is cancelled, so that the lens barrier 25 can move to the third position via the opened position as shown in FIG. 16. Consequently, in the camera 2B housed in the housing 5B, the lens barrier 25 is reliably moved to the third position, that is, the power source is turned on, so that the user does not miss the right moment to take a picture.

The operations of the image capturing system 1B are similar to those of the image capturing system 1A of the first preferred embodiment described with reference to the flowcharts of FIGS. 12 to 14 except that the on/off state of the switch SW 1 in the operation of housing determination in FIG. 13 is determined on the basis of whether the lens barrier 25 is moved to the third position or not.

With the configuration and operation of the image capturing system 1B, at the time of housing the camera 2B into the housing 5B, the lens barrier 25 of the camera 2B is moved to the third position by the barrier driving lever 61B. Thus, the power source of the camera 2B can be reliably turned on at the time of attaching the housing 5B.

### Third Preferred Embodiment

An image capturing system 1C according to a third preferred embodiment of the present invention is constructed by a camera 2C and a housing 5C for housing the camera 2C. The configuration will be described below.

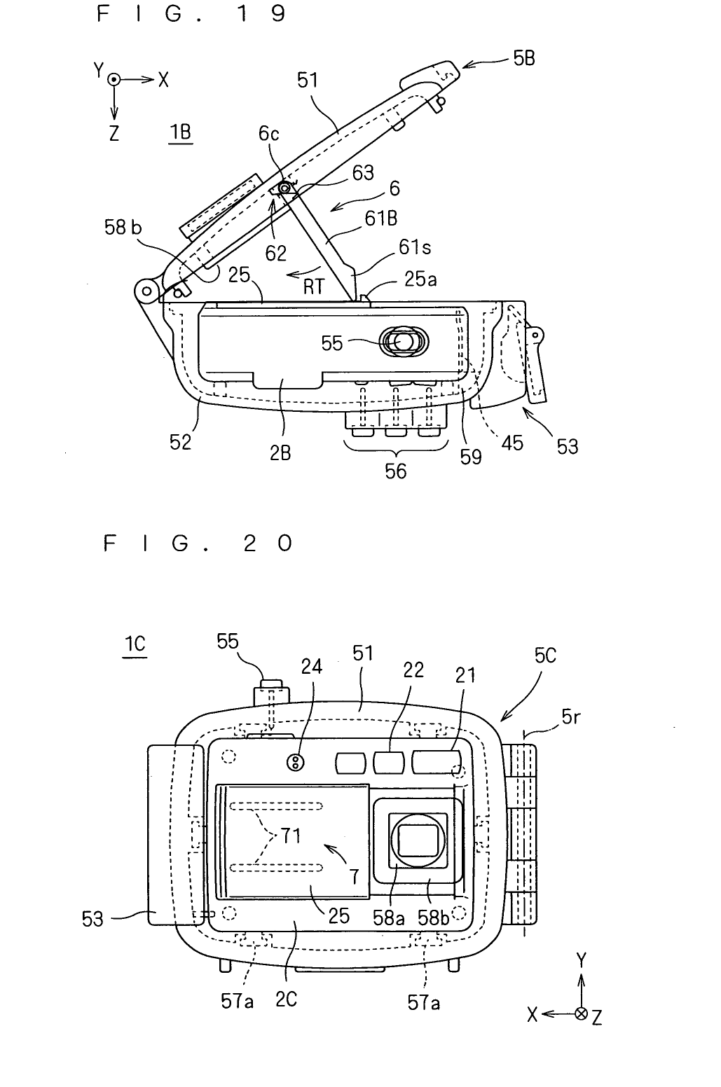

FIGS. 20 and 21 are diagrams showing the configuration of a main part of the image capturing system 1C. FIGS. 20 and 21 correspond to a front view and a top view of the image capturing system 1C, respectively, and show a state where the camera 2C is housed. A hatched portion in FIG. 21 corresponds to a cross section of the housing 5C.

The camera 2C has a configuration similar to that of the camera 2B of the second preferred embodiment shown in FIGS. 15 and 16 and has the barrier blocking lever 45.

The housing 5C has a configuration similar to that of the housing 5B of the second preferred embodiment shown in FIGS. 1S and 16 except for the point that an attachment preventing part 7 is provided in place of the barrier driver 6.

The attachment preventing part 7 has two attachment preventing ribs 71. Each of the attachment preventing ribs 71 has an elongated shape and is projected from the front housing S1.

As shown by the hatched portion in FIG. 21, when the lens barrier 25 of the camera 2C is in the third position, the tip of the attachment preventing rib 71 comes near to the front face of the lens barrier 25. As described above, when the lens barrier 25 is in the third position, the attachment preventing ribs 71 do not come into contact with the finger retaining part 25a of the lens barrier 25, so that the front housing 51 can be closed.

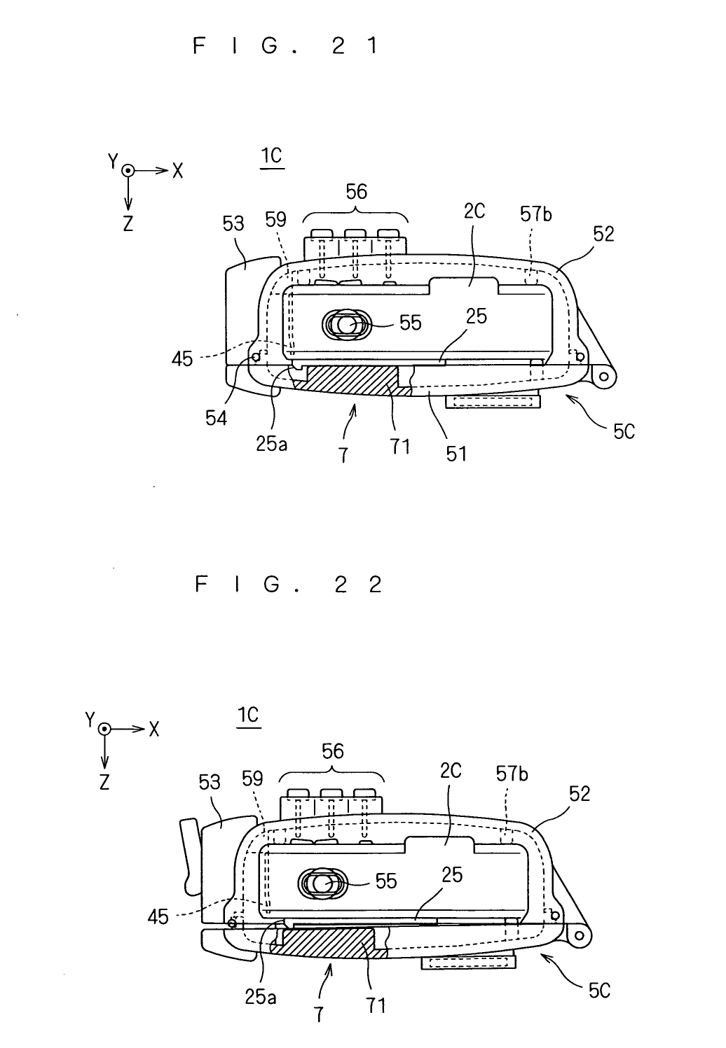

On the other hand, when the lens barrier 25 of the camera 2C is not in the third position but, for example, in the opened position, as shown in FIG. 22, the attachment preventing ribs 71 come into contact with the finger retaining part 25a and the front housing S1 is not perfectly closed. That is, in the case where the lens barrier 25 is not in the third position but is in the closed position and the opened position by the attachment preventing rib (blocking member) 71, completion of attachment of the housing 5C is blocked.

At the time of housing the camera 2C in the housing 5C, first, the camera 2C is set in the rear housing 52, the rib 59 for detecting a housing is made come into contact with the barrier blocking lever 45, the lens barrier 25 is slid to the third position and, after that, the front housing 51 is closed.

The operations of the image capturing system 1C are similar to those of the image capturing system 1A of the first preferred embodiment described with reference to the flowcharts of FIGS. 12 to 14 except that the on/off state of the switch SW1 in the housing determination operation in FIG. 13 is determined by checking whether the lens barrier 25 is moved to the third position or not.

With the configuration and operation of the image capturing system 1C described above, at the time of housing the camera 2C into the housing 5C, the lens barrier 25 has to be moved to the third position so that the finger retaining part 25a of the lens barrier 25 does not come into contact with the attachment preventing ribs 71, so that the power source of the camera 2C can be reliably turned on at the time of attaching the housing 5C.

### Fourth Preferred Embodiment

An image capturing system 1D according to a fourth preferred embodiment of the present invention is constructed by a camera 2D and a housing 5D for housing the camera 2D. The configuration will be described below.

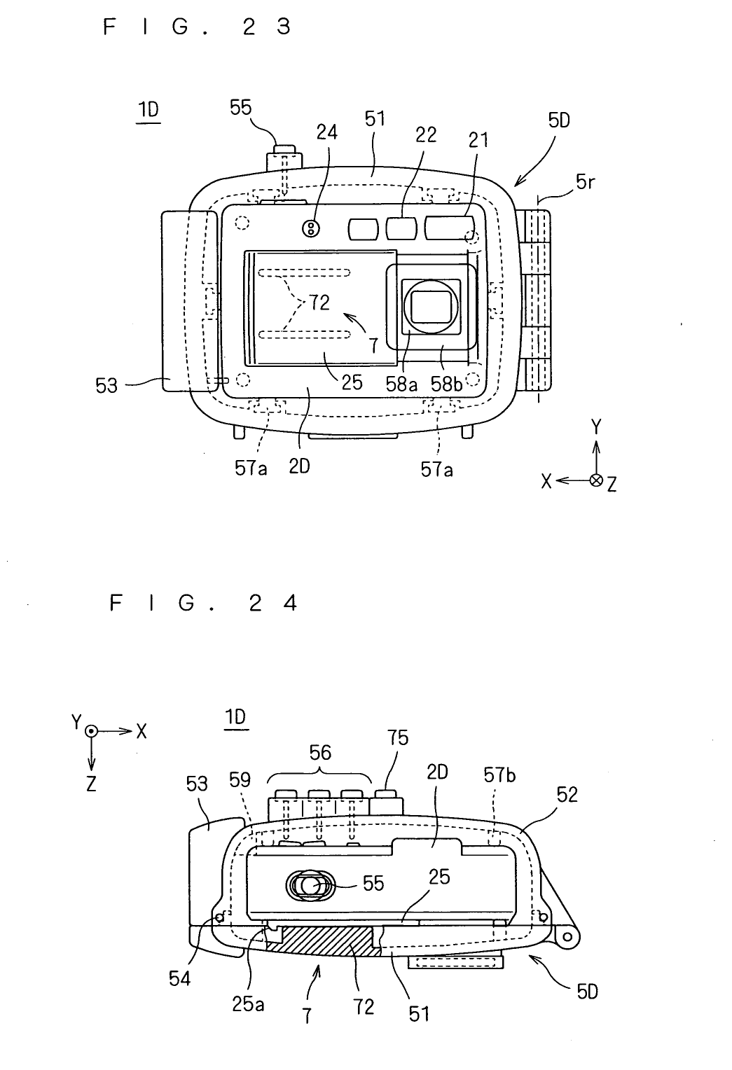

FIGS. 23 and 24 are diagrams showing the configuration of a main part of the image capturing system 1D. FIGS. 23 and 24 correspond to a front view and a top view of the image capturing system 1D, respectively, and show a state where the camera 2D is housed. A hatched portion in FIG. 24 corresponds to a cross section of the housing 5D.

The camera 2D has a configuration similar to that of the camera 2A of the first preferred embodiment shown in FIGS. 1 to 4. The lens barrier 25 can slide between the closed position and the opened position.

The housing 5D has a configuration similar to that of the housing 5C of the third preferred embodiment shown in FIGS. 20 and 21 except for the attachment preventing part 7.

The attachment preventing part 7 in the housing 5D has two attachment preventing ribs 72. The length in the longitudinal direction (X axis direction) of each of the attachment preventing ribs 72 is shorter than that of the attachment preventing rib 71 of the third preferred embodiment for the reason that, in contrast to the third preferred embodiment in which the lens barrier 25 can move to the third position, the lens barrier 25 can move to the opened position in the fourth preferred embodiment.

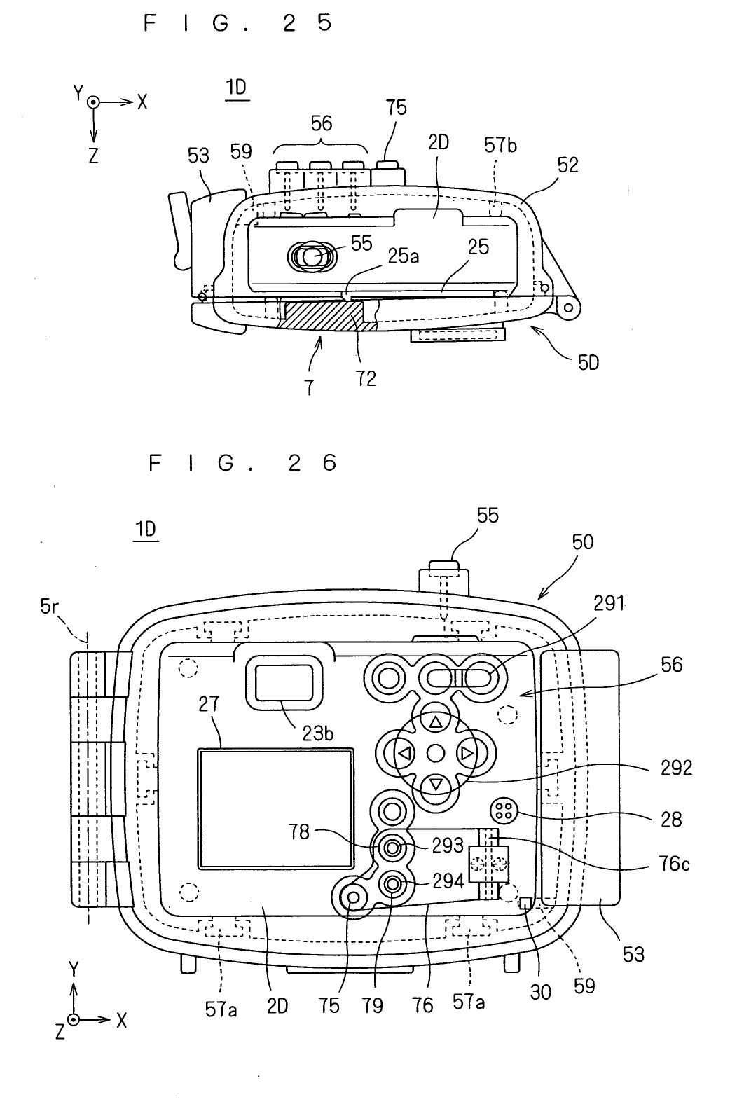

In a manner similar to the third preferred embodiment, when the lens barrier 25 is not in the opened position, completion of attachment of the housing 5C is blocked by the attachment preventing ribs 72 and the housing 5C is not perfectly closed as shown in FIG. 25.

Different from the housing 5C of the third preferred embodiment, an external power source button 75 is added to the housing 5D. The external power source button 75 will be described below.

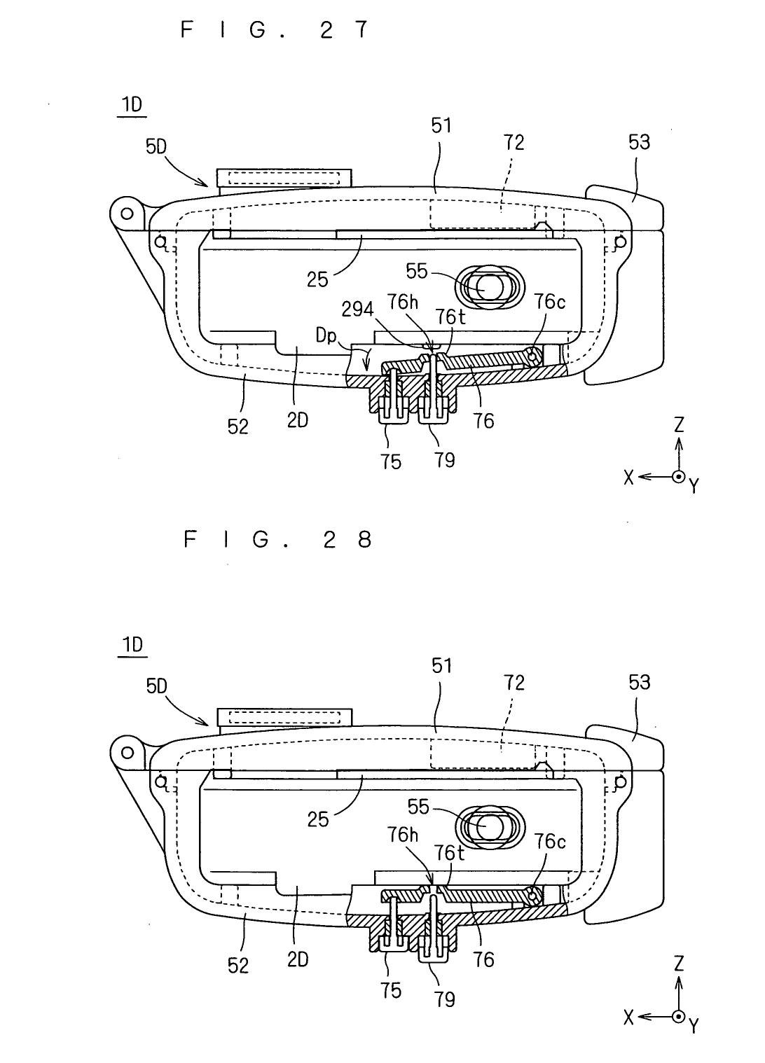

FIGS. 26 and 27 are diagrams showing the external power source button 75 in the housing 5D. FIGS. 26 and 27 correspond to a rear view and a top view of the image capturing system 1D, respectively, and show a state where the camera 2D is housed. A hatched portion in FIG. 27 corresponds to a cross section of the housing 5D.

In the camera 2D, the power source is turned on/off interlockingly with the opening/closing of the lens barrier 25, so that it is unnecessary to provide a power source button. However, in the housing 5D of the embodiment, the external power source button 75 is provided to enable the power source operation of the camera 2D to be performed over the housing. The tip of the external power source button 75 is in contact with the end of an interlocking lever 76 which can swing around a swing shaft 76c as a center. The interlocking lever 76 is energized in the direction Dp by, for example, a spring. The interlocking lever 76 has a projection 76t in a portion corresponding to the operation buttons 293 and 294 functioning as the switches SW3 and SW4 shown in FIG. 8 in the rear-face operation button part 29, and a hole 76h is formed in the central portion of the projection 76t. By the hole 76h, when the external operation button 78 or 79 is depressed, the operation button 293 or 294 of the camera 2D can be independently operated.

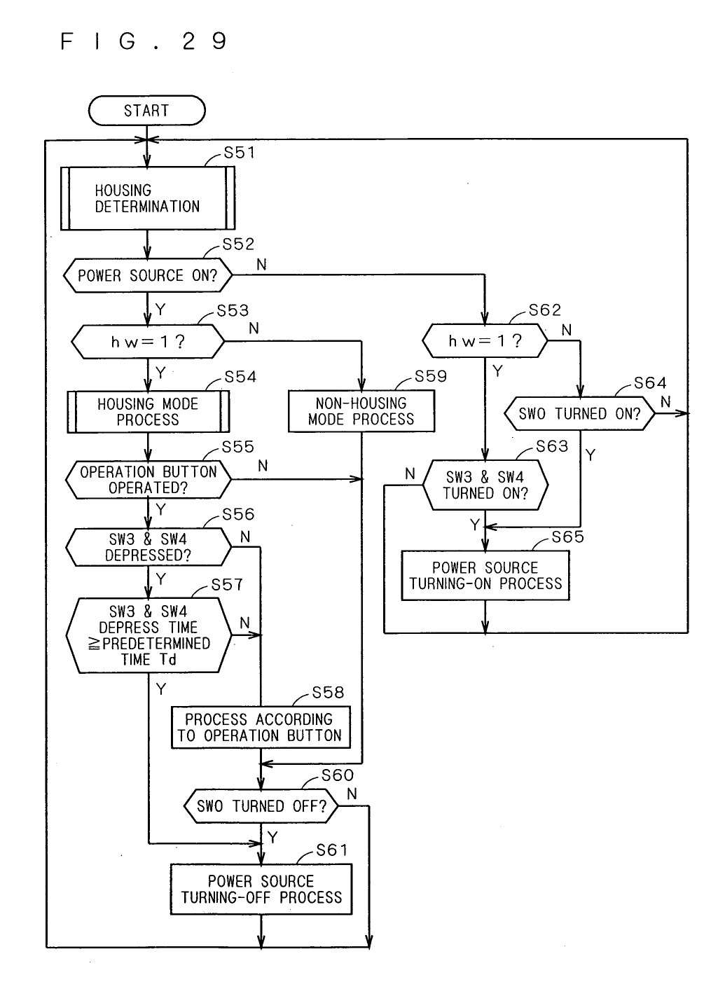

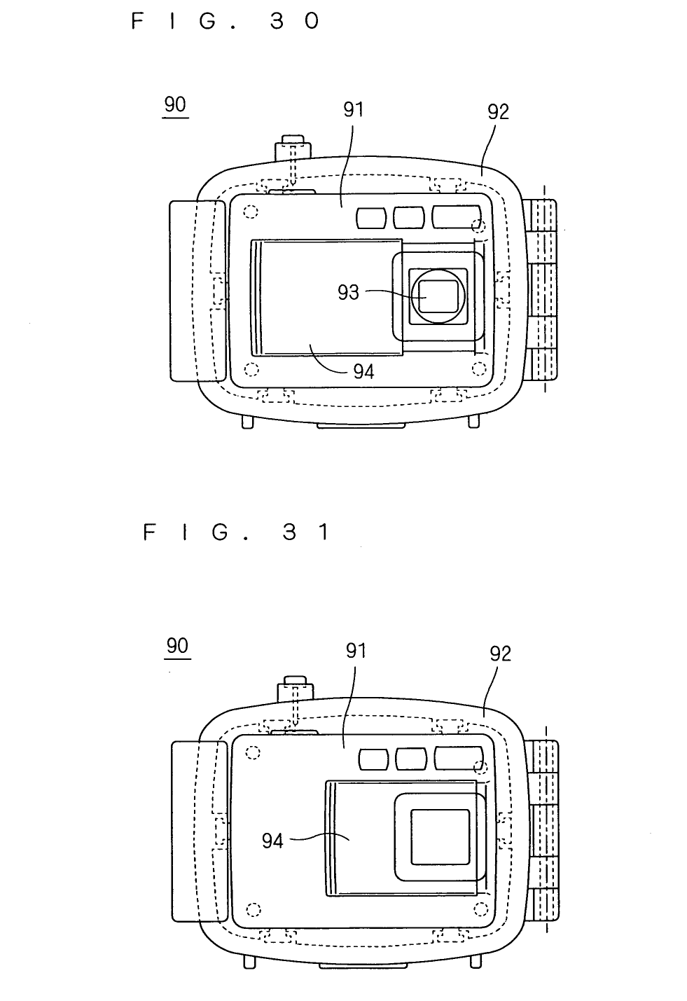

When the external power source button 75 is depressed by the user, by the mechanism in which the interlocking lever 76 swings around the swing shaft 76c as a center interlockingly with the depressing operation, the operation buttons 293 and 294 of the camera 2D are depressed as shown in FIG. 28. When the operation buttons 293 and 294 are simultaneously depressed, that is, when two members different from the lens barrier 25 are simultaneously operated, the camera 2D switches the on/off state of the power source. In the case where the on/off state of the power source of the camera 5D is switched after the camera 2D is housed in the housing, it is sufficient to depress one external power source button 75. On the other hand, the simultaneous operation of the operation buttons 293 and 294 is an operation which is not normally performed in the camera 2D itself. Consequently, the power source of the camera 2D is not turned off by mistake at the time of normal image capturing.

The operation of the image capturing system 1D will be described below.

FIG. 29 is a flowchart showing basic operations of the image capturing system 1D. The operations are executed by the controller 39 of the camera 2D.

In steps S51 to S55, operations similar to those in steps S1 to S5 in the flowchart of FIG. 12 are performed.

In step S56, whether the switches SW3 and SW4 in the operation buttons in the operation part 35 are simultaneously depressed or not is determined. In the case where the switches SW3 and SW4 are simultaneously depressed, the program advances to step S57. In the case where the switches SW3 and SW4 are not depressed, the program advances to step S58.

In step S57, whether depress time of the switches SW3 and SW4 is equal to or longer than predetermined time Td or not is determined. As described above, when the external power source button 75 is depressed, the operation buttons 293 and 294 corresponding to the switches SW3 and SW4 are simultaneously operated. Consequently, the depress time of the external power source button 75 is actually determined. In the case where the depress time of the switches SW3 and SW4 is equal to or longer than the predetermined time Td, the program advances to step S61. In the case where the depress time is less than the predetermined time Td, the program advances to step S58.

In steps S58 to S62, operations similar to those in steps S8 to S12 in the flowchart of FIG. 12 are performed.

In step S63, whether the switches SW3 and SW4 are on or not is determined. In this case, as described above, when the external power source button 75 is depressed, the operation buttons 293 and 294 corresponding to the switches SW3 and SW4 are simultaneously operated. Consequently, the depress state of the external power source button 75 is actually determined. In the case where the switches SW3 and SW4 are on, the program advances to step S65. In the case where the switches SW3 and SW4 are off, the program returns to step S51.

In steps S64 and S65, operations similar to those in steps S14 and S15 in the flowchart of FIG. 12 are performed.

With the configuration and operation of the image capturing system 1D, at the time of housing the camera into the housing 5D, the lens barrier 25 has to be moved to the opened position so that the finger retaining part 25a of the lens barrier 25 does not come into contact with the attachment preventing ribs 72, the power source of the camera 2D can be reliably turned on at the time of attaching the housing 5D. Further, the on/off state of the power source of the camera 2D can be switched by depressing the external power source button 75 provided for the housing 5D, so that the power source of the camera 2D can be operated even in a state where the camera 2D is housed in the housing.

While the invention has been shown and described in detail, the foregoing description is in all aspects illustrative and not restrictive. It is therefore understood that numerous modifications and variations can be devised without departing from the scope of the invention.

1. An image capturing apparatus to which a predetermined housing can be attached, comprising:
(a) a taking lens;
(b) a lens protection member which can be moved between a closed position where said taking lens is covered and an opened position where said taking lens is exposed; and
(c) a power source switcher which switches between a power-on state and a power-off state interlockingly with movement in an opened direction of said lens protection member and movement in a closed direction, wherein
said lens protection member is moved in said opened direction by a predetermined member provided for said predetermined housing in association with a work of attaching said predetermined housing.

2. The image capturing apparatus according to claim 1, wherein
said lens protection member is moved to said opened position by said predetermined member.

3. The image capturing apparatus according to claim 1, wherein
said lens protection member can be moved to a third position which is in an opened direction more than said opened position and is moved to said third position by said predetermined member.

4. The image capturing apparatus according to claim 1, further comprising:
(d) a selector for selecting between said power-on state and said power-off state by an operation on another member different from said lens protection member when said predetermined housing is attached.

5. The image capturing apparatus according to claim 1, further comprising:
(e) a detector for detecting an attached state where said predetermined housing is attached and an unattached state where said predetermined housing is not attached; and
(f) a controller for switching a control method on a specific control item between said attached state and said unattached state.

6. The image capturing apparatus according to claim 5, wherein
said specific control item is a control item related to underwater image capturing and includes at least one control item selected from the group consisting of an exposure control, a white balance control, an electronic flash control, an auto-focus control, a recording characteristic control, and a playback sound characteristic control.

7. An image capturing apparatus to which a predetermined housing can be attached, comprising:
(a) a taking lens;
(b) a lens protection member which can be moved among a closed position where said taking lens is covered, an opened position where said taking lens is exposed, and a third position which is in an opened direction more than said opened position; and
(c) a power source switcher which switches between a power-on state and a power-off state interlockingly with movement in an opened direction of said lens protection member and movement in a closed direction, wherein
when said lens protection member is not in said third position, completion of attachment of said predetermined housing is blocked by a predetermined member provided for said predetermined housing.

8. The image capturing apparatus according to claim 7, further comprising:
(d) a selector for selecting between said power-on state and said power-off state by an operation on another member different from said lens protection member when said predetermined housing is attached.

9. The image capturing apparatus according to claim 7, further comprising:
(e) a detector for detecting an attached state where said predetermined housing is attached and an unattached state where said predetermined housing is not attached; and
(f) a controller for switching a control method on a specific control item between said attached state and said unattached state.

10. The image capturing apparatus according to claim 9, wherein
said specific control item is a control item related to underwater image capturing and includes at least one control item selected from the group consisting of an exposure control, a white balance control, an electronic flash control, an auto focus control, a recording characteristic control, and a playback sound characteristic control.

11. An image capturing apparatus to which a predetermined housing can be attached, comprising:
(a) a taking lens;
(b) a lens protection member which can be moved between a closed position where said taking lens is covered and an opened position where said taking lens is exposed;
(c) a power source switcher which switches between a power-on state and a power-off state interlockingly with movement in an opened direction of said lens protection member and movement in a closed direction; and
(d) a selector for selecting between said power-on state and said power-off state by an operation on another member different from said lens protection member when said predetermined housing is attached, wherein
when said lens protection member is not in said opened position, completion of attachment of said predetermined housing is blocked by a predetermined member provided for said predetermined housing.

12. The image capturing apparatus according to claim 11, wherein
said predetermined member is constructed by a plurality of members, and
said predetermined housing has a mechanism for operating said plurality of members at the same time interlockingly with an operation on a predetermined operation member provided for said predetermined housing.

13. The image capturing apparatus according to claim 11, further comprising:
(e) a detector for detecting an attached state where said predetermined housing is attached and an unattached state where said predetermined housing is not attached; and
(f) a controller for switching a control method on a specific control item between said attached state and said unattached state.

14. The image capturing apparatus according to claim 13, wherein
said specific control item is a control item related to underwater image capturing and includes at least one control item selected from the group consisting of an exposure control, a white balance control, an electronic flash control, an auto-focus control, a recording characteristic control, and a playback sound characteristic control.

15. An image capturing system comprising:
(a) an image capturing apparatus comprising
(a-1) a taking lens,
(a-2) a lens protection member which can be moved between a closed position where said taking lens is covered and an opened position where said taking lens is exposed, and
(a-3) a power source switcher which switches between a power-on state and a power-off state interlockingly with movement in an opened direction of said lens protection member and movement in a closed direction; and
(b) a housing which is attached to said image capturing apparatus, comprising
(b-1) a driving member for moving said lens protection member in said opened direction in association with a work of attaching said housing.

16. An image capturing system comprising:
(a) an image capturing apparatus comprising
(a-1) a taking lens,
(a-2) a lens protection member which can be moved among a closed position where said taking lens is covered, an opened position where said taking lens is exposed, and a third position which is in an opened direction more than said opened position, and
(a-3) a power source switcher which switches between a power-on state and a power-off state interlockingly with movement in an opened direction of said lens protection member and movement in a closed direction; and
(b) a housing which is attached to said image capturing apparatus, comprising
(b-1) a blocking member for blocking completion of attachment of said housing when said lens protection member is not in said third position.

17. An image capturing system comprising:
(a) an image capturing apparatus comprising
(a-1) a taking lens,
(a-2) a lens protection member which can be moved between a closed position where said taking lens is covered and an opened position where said taking lens is exposed,
(a-3) a power source switcher which switches between a power-on state and a power-off state interlockingly with movement in an opened direction of said lens protection member and movement in a closed direction, and
(a-4) a selector for selecting between said power-on state and said power-off state by an operation on another member different from said lens protection member when said housing is attached; and
(b) a housing which is attached to said image capturing apparatus, comprising
(b-1) a blocking member for blocking completion of attachment of said housing when said lens protection member is not in said opened position.

18. A housing which is attached to an image capturing apparatus having a lens protection member which can be moved between a closed position where a taking lens is covered and an opened position where said taking lens is exposed, and a power source switcher which switches between a power-on state and a power-off state interlockingly with movement in an opened direction of said lens protection member and movement in a closed direction, the housing comprising:
(a) a housing body; and
(b) a driving member provided for said housing body and for moving said lens protection member in an opened direction interlockingly with a work of attaching said housing.

19. A housing which is attached to an image capturing apparatus having a lens protection member which can be moved between a closed position where a taking lens is covered and an opened position where said taking lens is exposed, and a power source switcher which switches between a power-on state and a power-off state interlockingly with movement in an opened direction of said lens protection member and movement in a closed direction, the housing comprising:
(a) a housing body; and
(b) a blocking member provided for said housing body, and for blocking completion of attachment of said housing when said lens protection member is not in a third position which is in an opened direction more than said opened position.

20. A housing which is attached to an image capturing apparatus having a lens protection member which can be moved between a closed position where a taking lens is covered and an opened position where said taking lens is exposed, and a power source switcher which switches between a power-on state and a power-off state interlockingly with movement in an opened direction of said lens protection member and movement in a closed direction, the housing comprising:
(a) a housing body; and
(b) a blocking member provided for said housing body, and for blocking completion of attachment of said housing when said lens protection member is not in said opened position, wherein
in said image capturing apparatus, when said housing is attached, said power-on state and said power-off state are switched by an operation on another member different from said lens protection member.
